(19) United States
(12) Patent Application Publication
(10) Pub. No.: US 2009/0254371 A1
(43) Pub. Date: Oct. 8, 2009

(54) Quality Assurance Methods for Medication Therapy Management

(76) Inventors: Samuel W. Bartholomew, III, Nashville, TN (US); Michael D. Hogue, Mt. Olive, AL (US); Scott A. McDaniel, Murfreesboro, TN (US); Bradley P. Tice, Franklin, TN (US)

Correspondence Address: Raymond R. Ferrera, 1221 McKinney Street, Suite 4400, Houston, TX, 77010, US

(21) Appl. No.: 12/328,941

(22) Filed: Dec. 5, 2008

Related U.S. Application Data
(60) Provisional application No. 61/005,469, filed on Dec. 5, 2007.

(51) Int. Cl. G06Q 50/00

(52) U.S. Cl. 705/3; 705/2

(57) ABSTRACT

A method for improving quality assurance methods for medication therapy management using a computer particularly adapted for a health care management or delivery organization is provided, the method including at least the steps of: providing a set of internal controls, wherein the internal controls further include a set of national guidelines and standards, as well as a qualified staff; and development by the qualified staff of a clinical rule based upon the national guidelines and standards. In other embodiments, a clinical quality assurance team further reviews the clinical rule developed by the staff. In further embodiments, a set of external controls is provided, wherein the external controls include one or more of a plurality of approved pharmacists, an external clinical advisory council, and/or an independent review board. In still further embodiments, one or more members of the set of external controls either validates the clinical rule developed by the staff, or validates a staff-developed clinical rule that was subsequently reviewed by the quality assurance team.

### CROSS-REFERENCE TO RELATED APPLICATIONS

The instant application claims the benefit of prior U.S. provisional application No. 61/005,469 file Dec. 5, 2007.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to a computer implemented system or method particularly adapted for a health care management or delivery organization, and more particularly wherein the system or method processes the records of diagnosis or treatment of a patient.

2. Description of Related Art

Under the Medicare Modernization Act of 2003, a medication therapy management program (MTM) is a program of drug therapy management that may be furnished by a pharmacist and that is designed to assure targeted beneficiaries that covered Medicare part D drugs under a prescription drug plan are appropriately used to optimize therapeutic outcomes through improved medication use, and to reduce the risk of adverse events, including adverse drug interactions (42 U.S.C. § 1395w-104(c)). Under the statute, individuals targeted by MTM programs are those who 1) have multiple chronic diseases (e.g., diabetes, asthma, hypertension, hyperlipidemia, and congestive heart failure), 2) are taking multiple drugs covered under Medicare part D, and 3) are identified as likely to incur annual costs for covered part D drugs that exceed a specified level.

Although Congress mandated the provision of MTM services only to such recipients, eleven national pharmacy organizations have agreed upon a more expansive definition of MTM as a set of services provided by pharmacists or other qualified health care providers. Such services may include: performing or obtaining assessments of patient health status; formulating a medication treatment plan; selecting, initiating, modifying and/or administering medication therapy; monitoring and evaluating patient response to therapy, including safety and efficacy; performing a comprehensive medication review to identify, resolve, and prevent medication related problems, including adverse drug events; documenting the care delivered and communicating essential information to a patient's primary care providers; providing verbal education and training designed to enhance patient understanding and appropriate use of medications; providing information, support services, and resources designed to enhance patient compliance with therapeutic regimens; and coordinating and integrating MTM services within the broader health care management services provided to patients.

The MTM service model represents an improvement over pharmacy benefit management systems, which focus principally on drug-based issues, and disease management systems, which focus principally on a patient's disease.

Pharmacy benefit management companies (PBMs) currently use software programs to identify certain drug-related problems. Examples of such companies include Caremark, Medco, and Pharmacare. Because PBMs manage only pharmacy claims, though, the drug-related problems identified are restricted to problems which are “drug only.” In other words, PBMs identify only high dosages, low dosages, drug-to-drug interactions, non-formulary drugs, early refills, late refills, therapeutic duplication (two dispensed drugs performing essentially the same function in the body), drug-gender interactions, and drug and dosage checks based upon age. When PBMs identify such problems, an electronic message is transmitted to the dispensing pharmacy at the time of claim submission to alert the pharmacist of the potential problem. In addition, many PBMs also send letters and/or faxes, and occasionally place telephone calls to prescribers to alert them of the potential problem. There is no guarantee, however, that these pharmacy or prescriber alerts are acted upon, and there is no consistent mechanism in place to ensure that the problem is actually resolved. PBMs do not have a recognized accreditation standard for quality related to the medication use process. To the inventors' knowledge, individual PBMs have not instituted comprehensive internal quality standards for the medication use process.

Disease management companies (DMs) partner with individual patients through their employer or health plan to provide disease-specific health and wellness education, and training. Examples of such companies include Healthways, Health Management Corporation, and Matria. The most common diseases for which DMs provide service are diabetes, asthma, smoking cessation, hypertension, multiple sclerosis, and hepatitis C. With regard to drugs, drug-related problems, and acute diseases, however, DMs do not provide consistent programs for identifying or resolving drug-related problems because their drug-related services are focused principally on ensuring that directions for use are reinforced and compliance with therapy is maintained. DMs do have quality assurance mechanisms, which include accreditation opportunities through NCQA. NCQA disease management quality measures currently do not assess medication therapy management programs, and thus DM companies have historically not measured or provided internally for quality monitoring of medication processes.

To address the shortcomings of PBMs and DMs, a few companies have developed methods of providing MTM services, but the services provided and the methods by which they are provided are distinct from those of the present invention. For example, Community MTM Services, Inc. (Community MTM) is a provider of MTM services and a subsidiary of the National Community Pharmacists Association (NCPA). Community MTM contracts with PBMs and employers to provide MTM services through the NCPA's network of independent community pharmacies (approximately 24,000 across the United States). Community MTM uses documentation software that allows collection of data in a common format for the purposes of reporting back to their clients and for determining compensation to their network. The company also utilizes basic Medicare-dictated criteria to identify patients needing MTM services, and then provides this information to a local pharmacist who is willing to provide the service. Pharmacists then have an open window of time (typically several weeks) to contact the eligible patient, invite them to the pharmacy for a face-to-face MTM encounter, document the encounter using the documentation software, and transmit the information collected to Community MTM. Afterward, payment is sent to the pharmacy for providing the service. If the pharmacist determines that an identified patient is deceased and informs Community MTM of this fact, Community MTM will pay the pharmacy for assisting in updating their records via the documentation system. If the pharmacist does not act or provide service to the identified patients, then the patients continue to roll back onto the eligibility list period after period. However, Community MTM has a very limited call center-based system in place to back-up their face-to-face network to ensure that pre-identified categories of eligible patients receive MTM services through their system. This is a limited quality assurance mechanism, but lacks patient and provider follow-up mechanisms and long-term tracking of patient outcomes. Community MTM allows any community pharmacy to participate in their network regardless of the qualifications or credentials of the pharmacist; the pharmacist must only be licensed to practice in the state in which they will provide service.

Another provider of MTM services is Outcomes Pharmaceutical Health Care (Outcomes), which uses a web-based documentation and billing system in conjunction with its network of pharmacists. Outcomes identifies eligible patients based upon the Medicare criteria of multiple chronic diseases, multiple drugs covered under Medicare part D being taken, and likelihood of incurring annual costs for covered part D drugs that exceed a specified level. Outcomes has two methods of providing MTM services to eligible patients: either Outcomes identifies eligible patients and notifies a willing pharmacist MTM provider; or a pharmacist MTM provider can use the web-based Outcomes benefit package to identify a needed patient intervention, provide the MTM service, and then bill Outcomes for the service. Outcomes has no method to identify at-risk patients; they let their face-to-face network know which patients are eligible (i.e., have covered service through Outcomes) but then rely on the network to actually screen patients for drug related problems. Thus, the Outcomes system does not have a system for ensuring quality in the medication use process for all enrolled beneficiaries from enrollment forward. Outcomes does not provide any mechanism for quality credentialing their network; any pharmacist willing to accept patients regardless of experiences or training is allowed to participate and provide service.

A third MTM service provider is excelleRx, Inc., a subsidiary of Omnicare. ExcelleRx is focused primarily on managing medications for hospice, end-of-life, and frail elderly patients. ExcelleRx owns three call centers and employs pharmacists, nurses, and a variety of technical staff to interface primarily with nurses caring for hospice and frail elderly patients. The company has developed patented clinical documentation software applications using stepped-care approaches to decision making to ensure a consistent level of service is provided by all employees. ExcelleRx was the first company to enter the market with services related to medication management. A key aspect of their delivery system is that the services provided are focused on the caregiver (usually a nurse) and problem-oriented. excelleRx does have internal quality assurance mechanisms to ensure the population on whom they are focused have appropriate interventions. Because excelleRx provides 100% of their medication therapy management services in-house, they do not have any experience in applying a quality standard for MTM beyond the internal environment.

### BRIEF SUMMARY OF THE INVENTION

The present invention addresses the aforementioned shortcomings of the prior art. In addition, the present invention provides for the most comprehensive quality assurance measures and mechanisms in the medication therapy management provider industry. National standards for medication therapy management quality are just now being considered jointly and individually by the Pharmacy Quality Alliance (PQA), the Centers for Medicare and Medicaid Services (CMS), America's Health Insurance Plans (AHIP), the National Community Pharmacists Association (NCPA), the National Association of Chain Drug Stores (NACDS), American Pharmacists Association (APhA), the Pharmaceutical Care Management Association (PCMA) and the National Committee for Quality Assurance (NCQA). The present invention is an example or model by which national standards may be developed.

In a method according to an embodiment of the present invention, clinical rules are developed, reviewed, and validated against standards of quality. A set of clinical rules is developed at step (30) by qualified internal staff (20), using national guidelines and standards (10). The clinical rules are then reviewed at step (50) by an internal clinical quality assurance team (40) according to guidelines promulgated by the national organizations in medicine and pharmacy generally recognized as having expertise in specific areas of medical care. The clinical rules are complex and unique, and comprise the latest and best clinical knowledge, outcomes data, and national standards for drug therapy and disease treatment, quality standards, and economic indicators. Upon reaching consensus internally, the rules are submitted to further review at validation step (90). Independently, and again using guidelines promulgated by the national organizations in medicine and pharmacy generally recognized as having expertise in specific areas of medical care, the clinical rules are reviewed in the validation process of step (90) by a panel of approved pharmacists (60), and by an external clinical advisory council and independent board comprising physicians and pharmacists (80). Approved pharmacists (60) are pharmacists (61) who have either earned a doctor of pharmacy (62) degree (Pharm.D.) and completed a post-doctoral residency program (63), or have become board certified (64) by the Board of Pharmaceutical Specialties. If disagreement (100) is present among the external advisors, documentation (110) to support the development of the rule (i.e., a rationale) is provided (120) and discussion may lead to refining the rule to alleviate disagreements and to achieve consensus (125). The result is a set of validated rules (130).

It will be appreciated by those skilled in the art that the validation process (90) performed by the panel of approved pharmacists (60), the external clinical advisory council and independent board comprising physicians and pharmacists (80) may proceed in series, with each subsequent reviewing body informed by the review of any prior reviewing body (for example, but without limitation, the external clinical advisory council could review the clinical rules first, submitting its conclusions and recommendations to the next reviewing body), or in parallel.

Included in the rule development is that when rules are developed, the corresponding interventions, including type (e.g., patient contact, physician contact, via phone, fax, email, text message, in person, etc.), content, frequency, and outcomes/result tracking are identified. Subsequently, when a rule/rule-set is run against patient data, a set of activities are automatically generated that lead to interventions by pharmacists and other clinicians. It is possible for the pharmacists and other clinicians to identify additional clinical interventions outside what was automatically generated by the PharmMD system. Regarding clinical interventions made by pharmacists in Applicant's network and by Applicant's internal staff, Applicant provides the following quality assurance mechanisms: a) clinical evaluators listen to and/or review recordings of interventions performed by call center staff, and provide remediation training if necessary based upon this review; b) clinical evaluators review documentation, including the interventions performed and future action plans developed, to ensure consistent communication amongst providers and to ensure complete follow-through on all recommendations; deficiencies identified result in remediation training, and persistent deficiencies in an individual's performance may result in the individual's termination from the network or company; c) inter-rater reliability evaluation is performed to ensure that all clinician interventions are consistent; d) credentialing of the pharmacist network is performed to include ensuring annually that each pharmacist: 1) is licensed and in good standing with their respective board of pharmacy; 2) is certified by a nationally or state recognized accrediting body such as the Board of Pharmaceutical Specialties, the Commission for Certification in Geriatric Pharmacy, the National Certification Board for Diabetes Educators, or other organization which provides certificate training recognized by the National Association of Boards of Pharmacy or other state or national regulatory agency; 3) has received post-graduate residency training in lieu of or in addition to the certification of 2). In addition, pharmacists who participate in Applicant's network receive training on the use of Applicant's proprietary documentation system. Call center personnel and network pharmacists also receive training in communication skills. Clinical interventions identified manually are logged and tracked for review and consideration for inclusion in the future development of rules and rule sets.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 is a flow diagram of a method according to the present invention for assuring improved quality in medication therapy management.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The National Committee for Quality Assurance (NCQA) is the organization nationally recognized for measuring healthcare quality. Neither the NCQA nor any other organization of which Applicant is aware has promulgated standard quality measures for medication therapy management services. The Academy of Managed Care Pharmacy (AMCP), the American Pharmacists Association (APhA), the American Society of Health-Systems Pharmacists (ASHP) and the National Association of Chain Drug Stores (NACDS) Foundation have all published a variety of manuscripts discussing the need for ensured quality in MTM service provision. Additionally, the Centers for Medicare & Medicaid Services (CMS), of the U.S. Department of Health & Human Services, has formed the Pharmacy Quality Alliance (PQA) for the purpose of beginning to draft quality measures against which to evaluate the MTM services being provided in the marketplace. The inception of MTM as a concept occurred in 2003. For the present invention no national standards have been put into place before moving forward with internal quality assurance procedures. The present invention utilizes the guideline that pharmacists are uniquely qualified due to their training to provide the very best and most comprehensive medication-related service. Pharmacists are involved at every step in the process of the present invention rather than rely upon external organizations and contracted agents to develop clinical rules. The present invention passes 100% of its intervention rules (The term “rules” is defined as clinical interventions reduced to computer code for automation of the process of identification of population in need of intervention) through internal pharmacist review so as to ensure each and every intervention rule meets standards of quality. For this, the involved pharmacists should either be nationally certified by the Board of Pharmaceutical Specialties as pharmacotherapy specialists, or to have received their pharmacy doctorate and have completed a post-doctoral residency program. These policies help to ensure a level of quality for the invention method higher than that exist in the MTM industry. All of the clinical intervention protocols are built upon national standards and guidelines for treatment of the disease(s) addressed, and include in-depth analysis of manufacturer and Food and Drug Administration (FDA) dosing, indications for use, precautions and contraindications for use. The clinical intervention protocols of the present invention are reviewed and validated by an external advisory board of clinical experts, including both physicians and pharmacists. Additionally, the invention includes recommendations of nationally recognized professional and governmental organizations (e.g., the American Pharmacists Association, the American Society of Health-Systems Pharmacists, National Institutes of Health, etc.) as they relate to treatment of disease and drug therapy management.

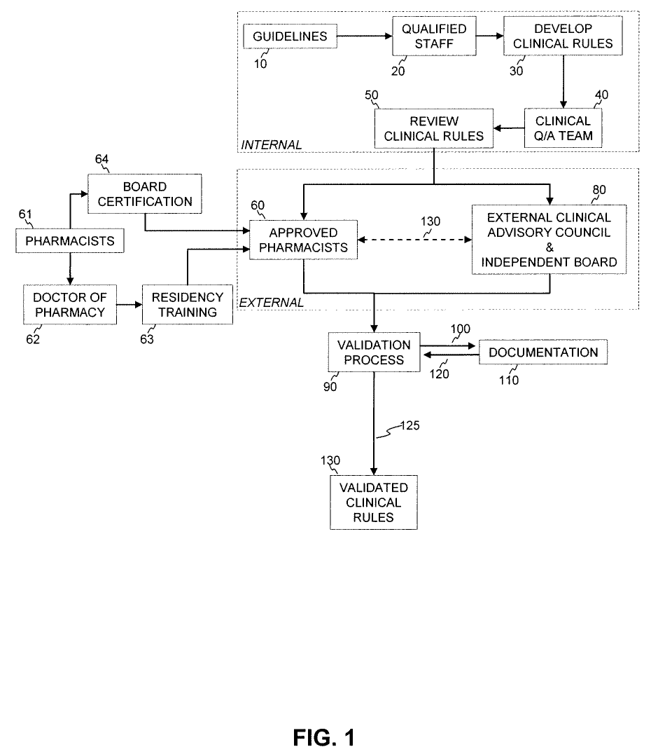

A flow diagram of a method for assuring improved quality in medication therapy management is shown in FIG. 1. Clinical rules are developed at step (30) by qualified staff (20), using national guidelines and standards (10). The rules developed at step (30) are reviewed further at step (50) by a clinical quality assurance team (40), using guidelines promulgated by the national organizations in medicine and pharmacy generally recognized as having expertise in specific areas of medical care. After the clinical quality assurance team (40) reaches consensus, the clinical rules are presented to three independent reviewing bodies for further review at step (90): a panel of approved pharmacists (60); and an external clinical advisory council and independent board comprising pharmacists and physicians (80). If external advisors (60, 80) raise disagreements (100) over any rule, either among themselves or between themselves (130), documentation (110) to support the rule's development (i.e., a rationale) is provided (120) and discussion may lead to refining or otherwise modifying the rule to resolve disagreements (100), achieve consensus (125), and so yield validated clinical rules (130).

Approved pharmacists (60) are pharmacists (61) who have either earned a doctor of pharmacy (62) degree (Pharm.D.) and completed a post-doctoral residency program (63), or have become board certified (64) by the Board of Pharmaceutical Specialties. The external clinical advisory council and independent board (80) is comprised of physicians and pharmacists.

For example, a set of rules (130) may be established to identify patients in need of intervention from within in a population of patients with diabetes. Such rules could include, without limitation, predictive parameters based on: age; race; serum creatinine (mg/dl); form of diabetes treatment (e.g., diet only, oral agents only, insulin only, or oral agents and insulin); mean LDL cholesterol (mg/dl), and albuminuria (present or absent). In one such method, beneficiaries with albuminuria, serum creatinine >2.0 mg/dl, and mean LDL cholesterol ≧100 mg/dl may be categorized as needing intervention. When the rule is developed, the background is established through a literature search and environmental scan to determine the impact of the rule. The numerator and denominator are then defined to enable rule coding and rule interventions and outcomes reporting are also established. A non-limiting example of a denominator is all patients diagnosed with diabetes, aged 18 to 75 years. A non-limiting example of a numerator is the number of patients from the denominator who received any test for microalbuminuria. Once this is complete, the rule is coded (i.e., computer code is developed that will enable the running of data) and the code is run for validation (90).

To validate (90) a rule, a data set is identified that contains patient claims data (e.g. medical and pharmacy) and other information (e.g., lab data) specific to that rule and has a large enough number of patients to provide statistical power and significance. The data is then run against the rule to determine how well the rule measures what was intended and to see how the population performs against the rule. For instance, if the rule was developed with the intent of identifying patients with diabetes that have an LDL cholesterol >100 mg/dl, the data is checked to verify that the programming code is identifying all of those patients and not falsely identifying patients. It also is run to identify how many and what percentage of patients are in that category to determine the impact running the rule and subsequent interventions will make within the patient population. For some rules (e.g. adherence to medications) it is necessary to establish where to set the threshold for intervention (e.g., for adherence, intervening when a person is not adherent with medication at 50%, 60%, 70%, 80%, or 90% levels).

Patient intervention paradigms are also established by type, content, and frequency, and are then delivered to patients identified by the validated rules (130). For example, and similarly to the example of validating (90) a rule, patient data (e.g., medical and pharmacy claims data, lab data, or other data relating to medical care delivered to a patient or data relating to the patient's health) is run against the validated rules (130) to identify patients in need of intervention. Non limiting examples of said intervention could include telephone calls to patients identified by the rules, brochures mailed to said patients, and direct contact with said patients' health care providers (including pharmacists and physicians). Benefit claims are then followed to identify (for example) patient outcomes, changes in the patient's health status, and use of health care resources. These data are followed to determine the impact and utility of the rule and subsequent interventions (i.e., to determine whether the validated rule, the rule's application to a patient population, and subsequent employment of the intervention paradigms produced a measurable or desirable change in patient health status and use of health care resources). This information is then used to assess the impact and utility of the rules, and the interventions, and to refine the rules and intervention strategies to deliver optimal medication therapy management.

All references cited in this specification are herein incorporated by reference as though each reference was specifically and individually indicated to be incorporated by reference. The citation of any reference is for its disclosure prior to the fling date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A method for improving quality assurance methods for medication therapy management using a computer particularly adapted for a health care management or delivery organization, wherein the method comprises the following steps:
a) providing a set of internal controls, wherein said internal controls further comprise a set of national guidelines and standards; and a qualified staff; and
b) development by the qualified staff of a clinical rule based upon the national guidelines and standards.

2. The method of claim 1, wherein said internal controls further comprise a clinical quality assurance team, which reviews the clinical rule developed by the staff.

3. The method of claim 1, further comprising:
providing a set of external controls, wherein said external controls further comprise one or more of a plurality of approved pharmacists, an external clinical advisory council, and an independent board.

4. The method of any of claims 1-3, wherein one or more members of a set of external controls either validates a clinical rule developed by the staff, or validates a staff-developed clinical rule that has subsequently been reviewed by a quality assurance team.

5. The method of claim 3, wherein said each pharmacist comprising said plurality of approved pharmacists either received their Doctor of Pharmacy degree and completed residency training, or is board certified.

6. The method of claim 5, further comprising the step of providing documentation to the panel of approved pharmacists, and to the external clinical advisory council and independent board to support the development of a validated clinical rule.

7. The method of claim 6, wherein said validation of the clinical rule further comprises:
a) identifying a data set containing patient claims data;
b) predicting whether the clinical rule will identify patients, whose collected data comprises the patient claims data, sought to be identified;
c) running said patient claims data against said clinical rule; and
d) determining whether patients identified by the clinical rule are those predicted to be identified.

8. The method of claim 7, further comprising:
a) running patient data against a validated clinical rule, thereby identifying individual patients;
b) providing medical intervention to said identified individual patients; and
c) monitoring subsequent health benefit claims of said patients provided with medical intervention.

9. The method of claim 8, wherein said monitoring comprises comparing
a) health benefit claims of said identified individual patients before said medical intervention; and
b) health benefit claims of said identified individual patients after said medical intervention.

10. The method of claim 8, wherein said monitoring comprises comparing
a) health benefit claims of said identified individual patients after said medical intervention; and
b) health benefit claims of identified individual patients that have not received medical intervention.
